(19) United States
(12) Patent Application Publication
(10) Pub. No.: US 2006/0091722 A1
(43) Pub. Date: May 4, 2006

(54) Brake apparatus with initial check function for actuator

(76) Inventors: Takashi Watanabe, Kariya-city (JP); Kenji Fujiwara, Kariya-city (JP); Yoshinori Suzuki, Kariya-city (JP); Yasunori Sakata, Kariya-city (JP); Yoshihiro Watanabe, Kariya-city (JP)

Correspondence Address: POSZ LAW GROUP, PLC, 12040 SOUTH LAKES DRIVE, SUITE 101, RESTON, VA, 20191, US

(21) Appl. No.: 11/251,975

(22) Filed: Oct. 18, 2005

(30) Foreign Application Priority Data
Oct. 28, 2004 (JP) 2004-313956

(51) Int. Cl. B60T 13/16

(52) U.S. Cl. 303/10

(57) ABSTRACT

A brake apparatus has two switching elements in an initial check function section, and detects a broken wiring failure of an actuator by turning on only one of the two switching elements. Therefore, during the initial check, a drive current does not flow through the actuator. Thus, it becomes possible to perform the initial check without operating the actuator. By making it possible to perform the initial check without operating the actuator in this manner, it becomes possible to prevent occurrence of the problem of rush current occurring when the actuator is operated for a short time and the problem of the switching elements being destroyed.

### CROSS REFERENCE TO RELATED APPLICATION

This application is based upon and claims the benefit of Japanese Patent Application No. 2004-313956 filed on Oct. 28, 2004, the content of which are incorporated herein by reference.

### FIELD OF THE INVENTION

The present invention relates to a brake apparatus provided with an initial check function that detects whether there is a broken wiring or the like, with respect to an actuator such as an electric motor for performing brake fluid pressure control, or the like.

### BACKGROUND OF THE INVENTION

A problem with the initial check on a brake apparatus provided with actuators, such as electric motors, solenoids and the like for performing brake fluid pressure controls, such as the ABS control and the like, is that if an actuator is actually operated for the initial check, the unusual noise caused by the driving of the actuator often makes a driver feel uneasy.

Therefore, there are related-art contrivances in which an electrical check and a mechanical check are separately performed, and during the electrical check, the driving duration of the actuator is shortened so as to avoid operation of the actuator, so that the unusual noise produced by the actuator is reduced (see, e.g., Japanese Patent Application Laid-Open Publication No. HEI 10-24826, and Japanese Patent Application Laid-Open Publication No. HEI 08-156772).

FIG. 8 shows a circuit construction for initial check provided in a related-art brake apparatus. FIG. 9 is a table summarizing actions performed by the circuit construction shown in FIG. 8 and the like at the time of the initial check.

As shown in FIG. 8, an actuator J1 and a switching element J2 are connected in series, to which a predetermined voltage generated by an electric power source J6 is applied. Furthermore, an intermediate potential between the actuator J1 and the switching element J2 is input to a detection circuit J3.

The detection circuit J3 has a partial resistor J4 and a partial resistor J5. The circuit J3 is constructed so that predetermined voltages are applied to the partial resistor J4 and the partial resistor J5 from the electric power source J6, and so that the intermediate potential is applied between the partial resistor J4 and the partial resistor J5. The potential between the partial resistor J4 and the partial resistor J5 is monitored. The initial check is performed on the basis of changes in the voltage monitor value. Incidentally, the partial resistor J4 and the partial resistor J5 have very large resistance values, and the current that flows from the electric power source J6 through the actuator J1 and the partial resistor J5 is very small, and therefore does not drive the actuator J1.

In this circuit construction, the initial check is performed as follows. With regard to the description below, it is to be noted that, of the wiring connected between the electric power source J6 and the ground via the actuator J1 and the switching element J2, the upstream side of an intermediate point between the actuator J1 and the switching element J2 will be referred to as “wiring A”, and the downstream side thereof will be referred to as “wiring B”.

Firstly, the voltage when the switching element J2 is off is monitored by the detection circuit. At this time, if the wiring is in a normal state where neither one of the wirings A, B has a break, no current flows through the actuator J1 because of the off state of the switching element J2, so that the voltage monitor value is at a high level.

However, if the wiring A has a break, the predetermined voltage applied by the electric power source J6 is divided by the partial resistor J4 and the partial resistor J5, so that the voltage monitor value is at a middle level. If the wiring B has a break, the voltage monitor value is at the high level as in the normal state. Furthermore, if both wirings A, B have a break, the predetermined voltage applied by the electric power source J6 is divided by the partial resistor J4 and the partial resistor J5, so that the voltage monitor value is at the middle level.

Subsequently, the switching element J2 is turned on, and a voltage at this time is monitored by the detection circuit. At this time, if the wiring is in the normal state where neither one of the wirings A, B has a break, the voltage monitor value is at a low level because of the on state of the switching element J2.

However, if the wiring A has a break, most of the current flowing through the partial resistor J4 on the basis of the predetermined voltage applied by the electric power source J6 flows to the ground through the switching element J2, so that the voltage monitor value is at the low level. Furthermore, if the wiring B has a break, the voltage monitor value is at the high level as in the corresponding case during the off state of the switching element J2. Still further, if both wirings A, B have a break, the predetermined voltage applied by the electric power source J6 is divided by the partial resistor J4 and the partial resistor J5, so that the voltage monitor value is at the middle level.

Therefore, as can be seen from FIG. 8, if the voltage monitor values actually obtained during the off state of the switching element J2 and during the on state thereof are different from the voltage monitor values that occur during the two states of the switching element J2 when the wiring is in the normal state, the location of a broken wiring can be detected from the actually obtained voltage monitor values.

However, if the driving duration of the actuator for the initial check is shortened, there arises a possibility of false determination, for example, determination of noise or the like as a failure, or the like.

Furthermore, in the case where the actuator to be initially checked is an electric motor, a large rush current occurs. Therefore, if in that case, the electrification of the actuator is switched off in a short time, other problems may occur; for example, destruction of a switching element that switches on and off the electrification of the actuator, or the like.

That is, as seen in FIG. 8, during the off state of the switching element J2, only a small current flows through the actuator J1, so that basically the actuator J1 does not operate. In contrast, during the on state of the switching element J2, a current flows through the actuator J1 for a short time, and the actuator J1 enters an operating state. Thus, a problem caused by rush current as mentioned above occurs.

### SUMMARY OF THE INVENTION

It is an object of the present invention to provide a brake apparatus capable of performing an initial check that does not cause an actuator to operate.

According to a first aspect of the present invention, a brake apparatus with an initial check function section includes two switching units, and detects an electrical abnormality of an actuator by turning on only one of the two switching units. Therefore, during the initial check, a drive current does not flow to the actuator. Thus, it becomes possible to perform the initial check without operating the actuator.

By performing the initial check without operating the actuator in this manner, it becomes possible to prevent occurrence of the problem of rush current occurring when the actuator is operated for a short time and the problem of the switching units being destroyed.

In the above-described construction, in a case where, upon generation of the output for operating only one of the two switching units, it is determined by the actuator state detection unit that the actuator is electrically normal based on the voltage between the two switching units detected by the voltage state detection unit, the drive unit may generate the output for operating only the other one of the two switching units.

Thus, only in the case where, upon operation of one of the two switching units, it is determined that the actuator is electrically normal, the other one of the switching units is also operated; therefore, the abnormality detection process to be performed if an abnormality occurs can be speeded up.

Furthermore, the actuator state detection unit may determine the actuator is electrically abnormal if the voltage between the two switching units detected by the voltage state detection unit continues to be a voltage indicating that the actuator is electrically abnormal, for a predetermined time.

Thus, by determining that there is an electrical abnormality of the actuator only after a voltage indicating that the actuator is electrically abnormal continues for a predetermined time, it becomes possible to perform the abnormality determination with increased accuracy.

Furthermore, the voltage state detection unit may include a first partial resistor and a second partial resistor that are connected in series with each other, and a current may be supplied to the first partial resistor and the second partial resistor from the electric power source, and a line where the first partial resistor and the second partial resistor are connected in series may be connected in parallel with the current supplying line where the two switching units and the actuator are connected in series.

On the basis of the voltage between the first and second partial resistors in the detection circuit, determination regarding electrical abnormality of the actuator can be performed.

In this construction, the actuator may be disposed between the two switching units, and a potential between the one of the two switching units and the actuator may be applied to the voltage state detection unit.

Furthermore, the actuator may be disposed between the two switching units, and a potential between the other one of the two switching units and the actuator may be input to the voltage state detection unit.

Still further, the actuator may be provided at a high side of the two switching units. The actuator may instead be provided at a low side of the two switching units.

In these constructions, when the drive unit drives one of the switching units, the actuator state detection unit may determine that the actuator is electrically normal if the voltage detected by the voltage state detection unit is at a high level or a low level, and the actuator state detection unit may determine that the actuator is electrically abnormal if the voltage detected by the voltage state detection unit is at a middle level.

### BRIEF DESCRIPTION OF THE DRAWINGS

Other objects, features and advantages of the present invention will be understood more fully from the following detailed description made with reference to the accompanying drawings. In the drawings:

FIG. 1 is a schematic diagram showing a hydraulic circuit construction of a brake apparatus with an initial check function according to a first embodiment of the present invention.

FIG. 2 is a block diagram showing a construction of an initial check function section in the brake apparatus shown in FIG. 1.

FIG. 3 is a table summarizing actions and the like in the initial check function section shown in FIG. 2 at the time of the initial check.

FIG. 4 is a flowchart of a failure detection process performed by the initial check function section shown in FIG. 2 during the initial check.

FIG. 5 is a block diagram showing a construction of an initial check function section in a brake apparatus according to a second embodiment of the present invention.

FIG. 6 is a block diagram showing a construction of an initial check function section in a brake apparatus according to a third embodiment of the present invention.

FIG. 7 is a block diagram showing a construction of an initial check function section in a brake apparatus according to a fourth embodiment of the present invention.

FIG. 8 is a block diagram showing a construction of an initial check function section in a related-art brake apparatus.

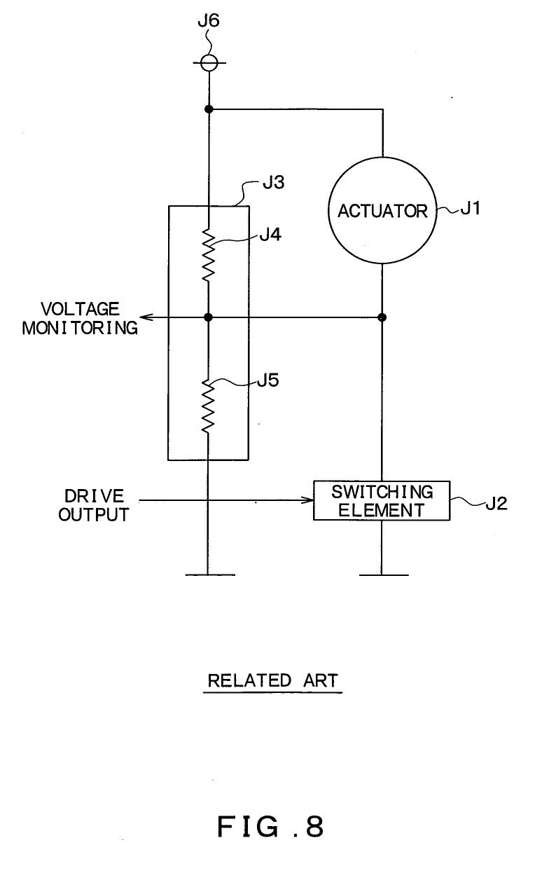

FIG. 9 is a table showing actions and the like in the initial check function section of the related-art brake apparatus at the time of the initial check.

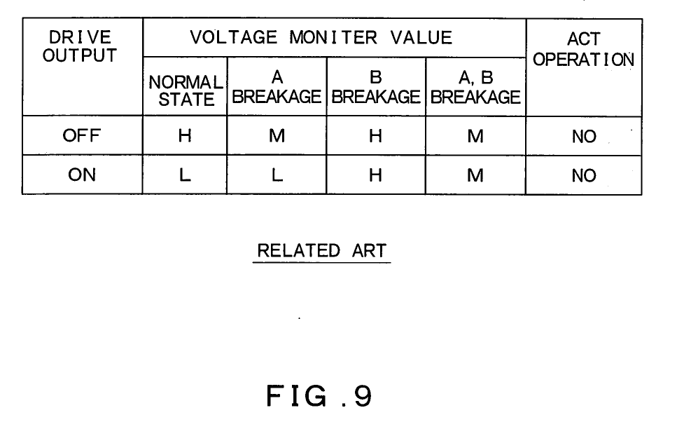

### DETAILED DESCRIPTION OF THE PREFERRED EMBODIMENTS

The present invention will be described further with reference to various embodiments in the drawings.

### First Embodiment

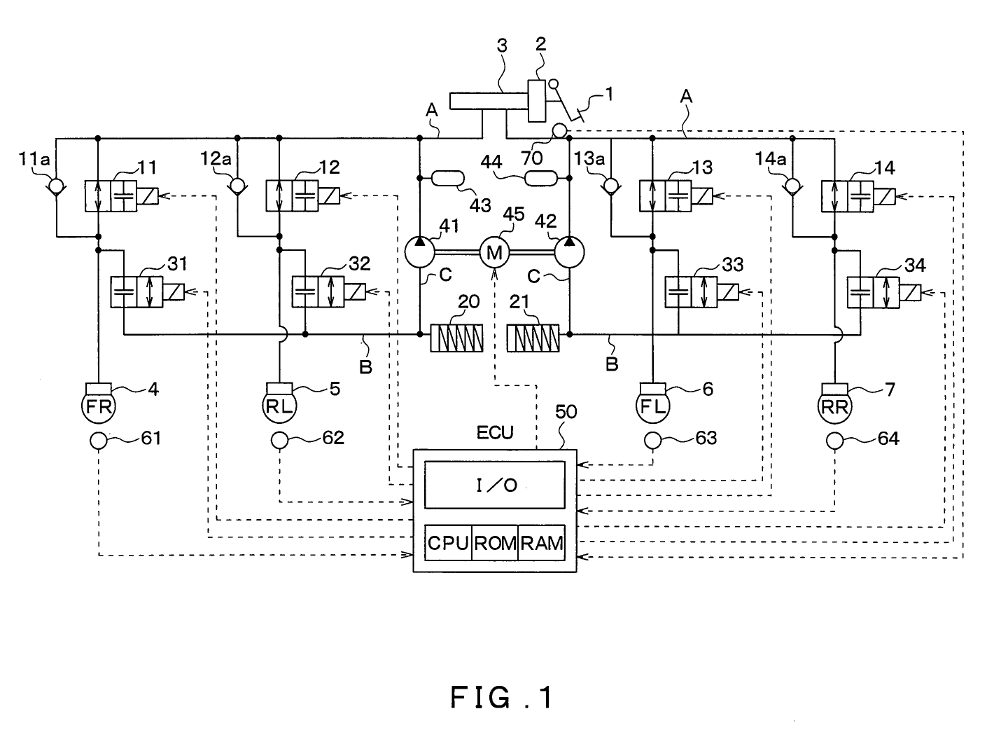

FIG. 1 shows a schematic diagram of brake conduits of a brake apparatus with an initial check function according to an embodiment of the present invention. A basic construction of the brake apparatus will be described hereinafter with reference to FIG. 1. The following description will be made in conjunction with an example in which a brake apparatus according to the present invention is applied to a vehicle having a hydraulic circuit of an X brake conduit layout in which a right front wheel-left rear wheel brake system and a left front wheel-right rear wheel brake system are provided. However, brake apparatuses having other brake conduit arrangements are also applicable.

As shown in FIG. 1, a brake pedal 1 that is depressed by an occupant to apply braking force to the vehicle is connected to a brake booster 2. The brake booster 2 boosts the brake pedal depressing force, or the like.

The brake booster 2 has a push rod that transmits the magnified depressing force to a master cylinder (hereinafter, referred to as “M/C”) 3. The push rod pressurizes a master piston provided in the M/C 3, thereby generating M/C pressure.

The M/C pressure is transmitted through the first brake system to a wheel cylinder (hereinafter, referred to as W/C) 4 for the front right wheel FR and to a W/C 5 for the rear left wheel RL, and is transmitted through the second brake system to W/Cs 6, 7 for the front left wheel FL and the rear right wheel RR.

Concretely, the M/C 3 and the W/Cs 4-7 are connected via a brake conduit (main brake conduit) A. The brake conduit A are provided with pressure increase control valves 11-14 corresponding to the W/Cs 4-7.

These pressure increase control valves 11-14 are each designed as a two-position valve of which open status and close status can be controlled by an electronic control unit (hereinafter, referred to as “ECU”) 50 provided for a brake fluid pressure control described below. When a two-position valve is controlled to the open status, the brake fluid pressure based on the M/C pressure or the like can be applied to a corresponding one of the W/Cs 4-7. These pressure increase control valves 11-14 are usually controlled to the opens status during a normal brake state where the brake fluid pressure control, such as the ABS control or the like, is not executed.

Incidentally, the pressure increase control valves 11-14 are provided with safety valves 11a-14a, respectively, which are connected in parallel therewith so that when the brake pedal 1 is released during operation of the ABS, the brake fluid can be accordingly discharged from the side of W/Cs 4-7.

The brake conduit A between the pressure increase control valves 11-14 and the corresponding W/Cs 4-7 are connected to reservoirs 20, 21 via a brake conduit B. By relieving the brake fluid to the reservoirs 20, 21 through the brake conduit B, the brake fluid pressure in the W/Cs 4-7 is controlled so as to prevent the wheels from leading to a locking tendency.

The brake conduit B connecting between the W/Cs 4-7 and the reservoirs 20, 21 are provided with pressure decrease control valves 31-34, respectively, whose opens status and close status can be controlled by the ECU 50. These pressure decrease control valves 31-34 are usually in the close status during the normal brake state (during non-operation of the ABS), and are appropriately controlled to the open status when the brake fluid is relieved to the above-described reservoirs 20, 21.

The reservoirs 20, 21 are connected to the corresponding brake conduit A via a brake conduit C. The brake conduit C connecting the reservoirs 20, 21 and the brake conduit A are provided with pumps 41, 42 and with accumulators 43, 44, respectively. The pumps 41, 42 are driven by an electric motor 45 on the basis of a signal from the ECU 50. When the electric motor 45 is driven, the brake fluid relieved in the reservoirs 20, 21 is drawn and ejected by the pumps 41, 42, and the brake fluid from the pumps is returned to the brake conduit A after pulsation is suppressed by the accumulators 43, 44.

In this manner, the hydraulic unit in the brake apparatus of this embodiment is constructed. In order to drive the hydraulic unit, wheel speed sensors 61-64 for detecting the wheel speeds of the wheels FR, FL, RR, RL, respectively, are provided, and a stop switch 70 for detecting whether or not the brake pedal 1 is depressed is provided. Detection signals from these sensors 61-64, 70 are input to the ECU 50.

The ECU 50 is formed by a well-known microcomputer that has a CPU (including a counter), a ROM, a RAM, an I/O, etc. The ECU 50, following programs stored in the ROM or the like, executes the ABS control and the like, and performs the initial check of detecting whether or not there is a failure in an actuator that constitutes the brake apparatus, for example, the electric motor 45 in this embodiment.

For example, when power is supplied to the ECU 50 upon the turning on of an ignition switch (not shown), the ECU 50 performs various computations on the basis of detection signals from the aforementioned wheel speed sensors 61-64 and a detection signal from the stop switch 70. Concretely, the ECU 50 computes the slip ratios of the wheels FR, FL, RR, RL, and performs computations for the brake fluid pressure control. If the pressure increase control valves 11-14 and the pressure decrease control valves 31-34 are driven, the ECU 50 outputs corresponding drive signals, and also outputs a drive signal to the electric motor 45 in order to drive the pumps 41, 42. Thus, the ABS control or the like is executed so as to avoid slip of a wheel.

The initial check of the actuator that constitutes the brake apparatus is performed by an initial check function section provided in the ECU 50.

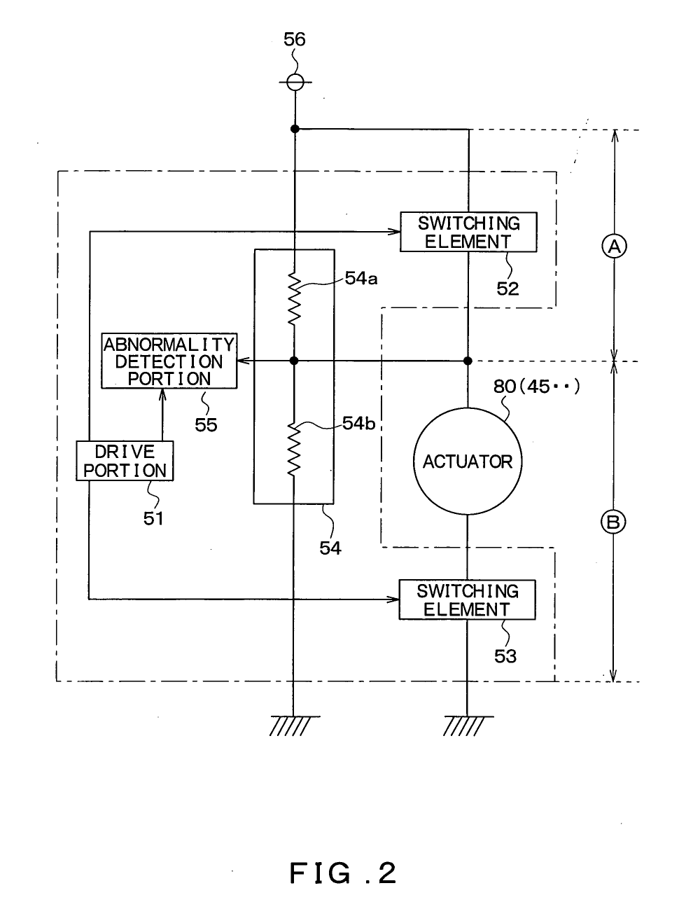

FIG. 2 illustrates only the initial check function section in the ECU 50. In FIG. 2, the reference numeral given to the actuator is not the same as the reference numeral of the corresponding actual component part shown in FIG. 1. Concretely, however, the actuator is the electric motor 45 or the like, as mentioned above.

As shown in FIG. 2, the ECU 50 is provided with a drive portion 51, switching elements 52, 53, a detection circuit 54, and an abnormality detection portion 55.

The drive portion 51 drives the switching elements 52, 53, in order to perform detection of an electrical failure of the actuator 80, for example, detection of an electrical abnormality in which an electric power supplying line to the actuator 80 is broken resulting in the impossibility of driving the actuator 80. The drive portion 51 corresponds to a drive output unit according to the present invention. The method of driving the switching elements 52, 53 by the drive portion 51 will be described in detail later.

The switching element 52 and the switching element 53 are connected in series with the actuator 80 in an electric power supplying line that connects between the electric power source 56 and the ground. These switching elements 52, 53 are provided for performing the initial check while preventing current from flowing from the electric power source 56 to the actuator 80, and correspond to a switching unit according to the present invention.

The switching element 52 is disposed at a high side of the actuator 80, and the switching element 53 is disposed at a low side of the actuator 80. A construction is provided such that a potential between the switching element 52 and the actuator 80 is input to the detection circuit 54.

The detection circuit 54 is connected between the electric power source 56 and the ground, in parallel with the line of the switching elements 52, 53 and the actuator 80. The detection circuit 54 is formed by a partial resistor 54a and a partial resistor 54b that are connected in series with each other. The partial resistor 54a and the partial resistor 54b have sufficiently large resistance values so that substantially no current flows through the partial resistor 54a or the partial resistor 54b. Therefore, even if current flows from the electric power source 56 to the actuator 80 through the partial resistor 54a, the current is very small, and therefore does not drive the actuator 80. Incidentally, the detection circuit 54 corresponds to a voltage state detection unit in the present invention.

The abnormality detection portion 55 receives an output voltage of the detection circuit 54, that is, a voltage between the partial resistor 54a and the partial resistor 54b, as a voltage monitor value, and detects an electrical failure of the actuator 80 on the basis of the voltage monitor value. The abnormality detection portion 55 is designed so that drive signals for the switching elements 52, 53 are input from the drive portion 51. Thus, the abnormality detection portion 55 is informed of the on/off state of each of the switching elements 52, 53. This abnormality detection portion 55 corresponds to an abnormality detection unit in the present invention.

The initial check function section constructed as mentioned above executes an abnormality detection process for initial check. In the abnormality detection process, abnormality detection is performed on the basis of the following principle.

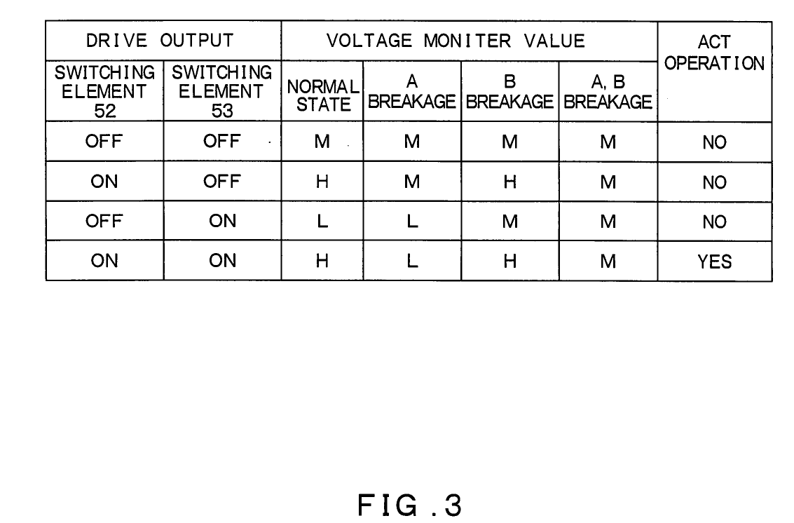

The principle of the initial check of the actuator 80 will be described with reference to the table shown in FIG. 3, in which actions and the like at the time of the initial check are summarized. With regard to the following description, it is to be noted that, of the wiring connected between the electric power source 56 and the ground via the switching elements 52, 53, the upstream side of an intermediate point between the actuator 80 and the switching element 52 will be referred to as “wiring A”, and the downstream side thereof will be referred to as “wiring B”.

Firstly, when the voltage monitor value is monitored by the abnormality detection portion 55 while the switching elements 52, 53 are both in the off state, the following situations can occur. That is, as shown in FIG. 3, if the wiring is in a normal state where neither one of the wirings A, B has a break, no current flows through the actuator 80 because of the off state of both switching elements 52, 53, so that the voltage monitor value is at a middle level. If during this state of the switching elements 52, 53, either the wiring A or the wiring B or both of them have a break, the predetermined voltage applied by the electric power source 56 is merely divided by the partial resistor 54a and the partial resistor 54b as in the aforementioned case, so that the voltage monitor value is also at the middle level.

Furthermore, when the voltage monitor value is monitored by the abnormality detection portion 55 while the switching element 52 is on and the switching element 53 is off, the following situations can occur. As shown in FIG. 3, if the wiring is in the normal state where neither one of the wirings A, B has a break, the voltage monitor value is at a high level because of the on state of the switching element 52. In contrast, if the wiring A has a break, the voltage monitor value is at the middle level as in the case where the switching element 52 is off. If during this state of the switching elements 52, 53, the wiring B has a break, the voltage monitor value varies depending on whether or not the wiring A has a break. If the wiring A is in a normal state, the voltage monitor value is at the high level. If the wiring A has a break, the voltage monitor value is at the middle level.

When the voltage monitor value is monitored by the abnormality detection portion 55 while the switching element 52 is off and the switching element 53 is on, the following situations can occur. As shown in FIG. 3, if the wiring is in the normal state where neither one of the wirings A, B has a break, the voltage monitor value is at a low level because of the on state of the switching element 53. In contrast, if the wiring B has a break, the voltage monitor value is at the middle level as in the case where the switching element 53 is off. If during this state of the switching elements 52, 53, the wiring A has a break, the voltage monitor value varies depending on whether or not the wiring B has a break. If the wiring B is in a normal state, the voltage monitor value is at the low level. If the wiring B has a break, the voltage monitor value is at the middle level.

As can be seen from FIG. 3, if during the state where one of the switching elements 52, 53 is on and the other one is off, the voltage monitor value actually obtained is different from the voltage monitor value that occurs during the same state of the switching elements 52, 53 when the wiring is in the normal state, the location of a broken wiring can be detected from the actually obtained voltage monitor value.

Concretely, if the voltage monitor value is at the middle level when the switching element 52 is on and the switching element 53 is off, it can be understood that at least the wiring A has a break. If in that case, the voltage monitor value is at the low level when the switching element 52 is off and the switching element 53 is on, it can be understood that only the wiring A has a break. If the voltage monitor value is at the middle level in the same situation, it can be understood that the wring B also has a break.

If the voltage monitor value is at the high level when the switching element 52 is on and the switching element 53 is off, it can be understood that at least the wiring A does not have a break. If in that case, the voltage monitor value is at the middle level when the switching element 52 is off and the switching element 53 is on, it can be understood that only the wiring B has a break. If the voltage monitor value is at the low level in the same situation, it can be understood that neither one of the wirings A, B has a break.

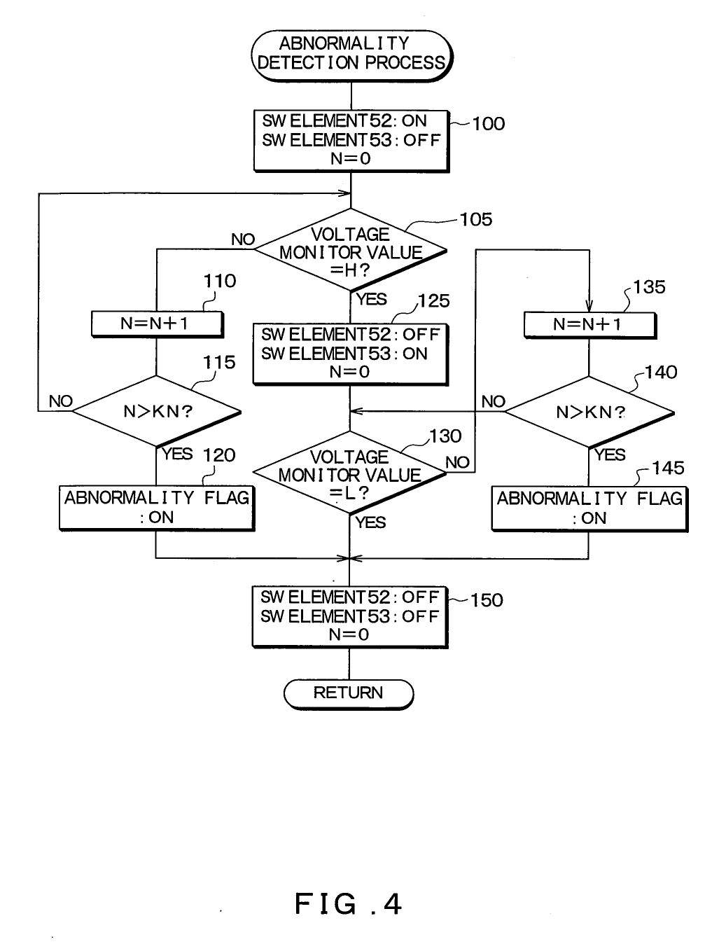

Therefore, the ECU 50 in the brake apparatus of this embodiment executes the abnormality detection process in the following manner. FIG. 4 shows a flowchart of the abnormality detection process in the initial check. With reference to this flowchart, the following description will be made.

When the ignition switch (not shown) is turned on, the ECU 50 executes the abnormality detection process in the initial check in accordance with the flowchart shown in FIG. 4.

Firstly at 100 in FIG. 4, the switching element 52 is set to the on state, and the switching element 53 is set to the off state. Furthermore, the count value N of a counter is reset to zero. Then, the processing proceeds to 105, at which it is determined whether the voltage monitor value is at the high level. If a negative determination is made, it is considered that the wiring A may possibly have a break. Then, the processing proceeds to 110, at which the count value N of the counter is incremented by 1. After that, the processing proceeds to 115.

At 115, it is determined whether the count value N of the counter has exceeded the predetermined number of times KN. The predetermined number of times KN herein refers to a value of degree which provides a certain reliability for the determination that the wiring A may possibly have a break, and which has been set to prevent a noise-like determination that the wiring A has a break. For example, the predetermined number of times KN is set at a value such that if the determination that the wiring A has a break has been repeated at 105 for 100 seconds, an affirmative determination is made at 115. Therefore, it becomes possible to perform more accurate abnormality determination.

If a negative determination is repeated at 105 so that the count value N of the counter exceeds the predetermined number of times KN, the processing proceeds to 120, at which an abnormality flag indicating that an abnormality is occurring with regard to the wiring A is set.

Conversely, if an affirmative determination is made at 105, the processing proceeds to 125, at which the switching element 52 is set to the off state and the switching element 53 is set to the on state. Furthermore, the count value N of the counter is reset to zero. Then, the processing proceeds to 130, at which it is determined whether or not the voltage monitor value is at the low level. If a negative determination is made in this case, it is considered that the wiring B may possibly have a break, and the processing proceeds to 135, at which the count value N of the counter is incremented by 1. After that, the processing proceeds to 140.

Subsequently at 140, it is determined whether or not the count value N of the counter has exceeded the predetermined number of times KN as in the processing at 115. The predetermined number of times KN herein is substantially the same as the predetermined number of times KN set at 115.

Then, if a negative determination is repeated at 130 so that the count value N of the counter exceeds the predetermined number of times KN, the processing proceeds to 145, at which an abnormality flag indicating that an abnormality is occurring with regard to the wiring B is set.

After determination regarding an abnormality of the wiring A and the wiring B, the processing proceeds to 150, at which the switching elements 52, 53 are turned off and the count value N of the counter is reset to zero, thus completing the electrical abnormality detection process in the initial check of the actuator 80.

As described above, in the brake apparatus of the embodiment, the initial check function section is provided with the two switching elements 52, 53, and a broken wiring failure of the actuator 80 is detected by turning on only one of the two switching elements 52, 53. Therefore, it becomes possible to perform the initial check without causing a drive current to flow to the actuator 80 and therefore without causing the actuator 80 to operate as indicated in FIG. 3 during the initial check.

By allowing the initial check to be performed without operating the actuator 80, it becomes possible to prevent occurrence of a problem of rush current occurring when the actuator 80 is operated for a short time, or a problem of the switching elements 52, 53 being broken.

Incidentally, if it is desired to operate the actuator 80 after the initial check completes, the actuator 80 can be operated by turning both the switching elements 52, 53 on as indicated in FIG. 3.

Furthermore, as described above in conjunction with the abnormality detection process, if it is detected that the wiring A has a break, the abnormality flag is set without waiting to detect a break of the wiring B. In this manner, the abnormality detection process in the case where an abnormality has been detected can be speeded up.

### Second Embodiment

A second embodiment of the present invention will be described. The brake apparatus of this embodiment is modified from the first embodiment, in respect of the circuit construction of the initial check function section in the ECU 50, with all the other constructions being the same as those of the first embodiment. Therefore, only different portions will be described.

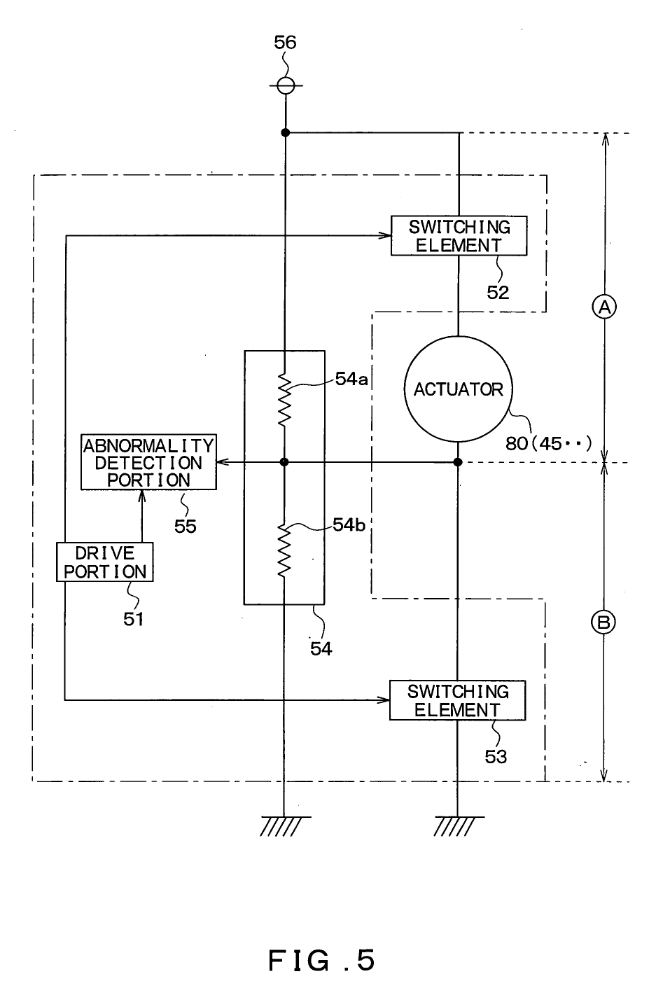

FIG. 5 illustrates a circuit construction of the initial check function section of the ECU 50 in the brake apparatus of this embodiment.

As shown in FIG. 5, in the initial check function section of the ECU 50 in the brake apparatus of the present embodiment, a voltage between the actuator 80 and the switching element 53 is input to the detection circuit 54. Other constructions are substantially the same as those of the first embodiment.

As for the initial check function section as described above, the relationship between the on and off states of the switching elements 52, 53 and the broken states of the wirings A, B is substantially the same as the relationship in the first embodiment shown in FIG. 3. Therefore, by executing the abnormality detection process that is substantially the same as that in the first embodiment shown in FIG. 4, it is possible to detect a broken wiring failure of the wirings A, B. Hence, the second embodiment can achieve substantially the same advantages as the first embodiment.

### Third Embodiment

A third embodiment of the present invention will be described. The brake apparatus of this embodiment is modified from the first embodiment, in respect of the circuit construction of the initial check function section in the ECU 50, with all the other constructions being the same as those in the first embodiment. Therefore, only different portions will be described.

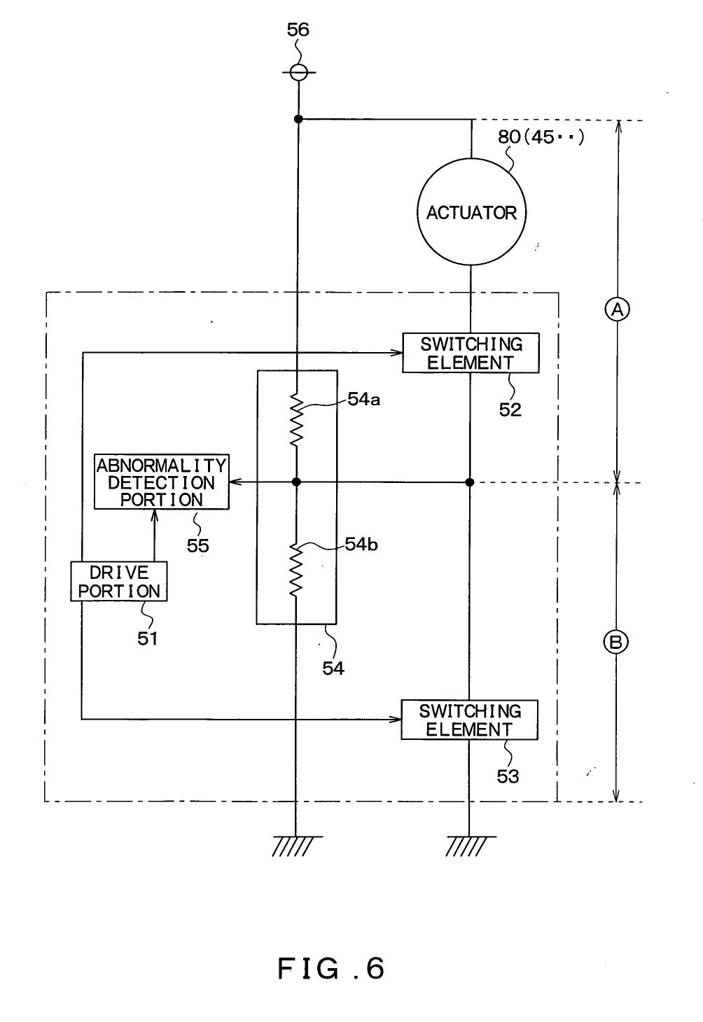

FIG. 6 illustrates a circuit construction of the initial check function section of the ECU 50 in the brake apparatus of this embodiment.

As shown in FIG. 6, in the initial check function section of the ECU 50 in the brake apparatus of this embodiment, the actuator 80 is disposed at the high side of the switching element 52, and a voltage between the switching element 52 and the switching element 53 is input to the detection circuit 54. Other constructions are substantially the same as those of the first embodiment.

As for the initial check function section as described above, too, the relationship between the on and off states of the switching elements 52, 53 and the broken states of the wirings A, B is substantially the same as the relationship in the first embodiment shown in FIG. 3. Therefore, by executing the abnormality detection process that is substantially the same as that in the first embodiment shown in FIG. 4, it is possible to detect a broken wiring failure of the wirings A, B. Hence, the third embodiment can achieve substantially the same advantages as the first embodiment.

### Fourth Embodiment

A fourth embodiment of the present invention will be described. The brake apparatus of this embodiment is modified from the first embodiment, in respect of the circuit construction of the initial check function section in the ECU 50, with all the other constructions being the same as those in the first embodiment. Therefore, only different portions will be described.

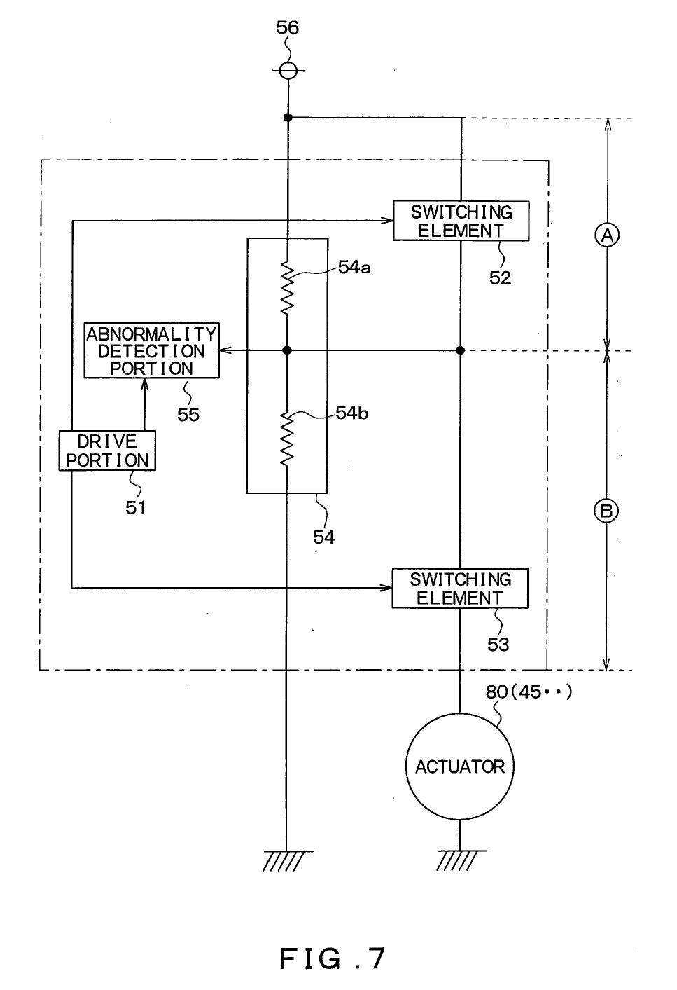

FIG. 7 illustrates a circuit construction of the initial check function section of the ECU 50 in the brake apparatus of this embodiment.

As shown in FIG. 7, in the initial check function section of the ECU 50 in the brake apparatus of this embodiment, the actuator 80 is disposed at the low side of the switching element 53, and a voltage between the switching element 52 and the switching element 53 is input to the detection circuit 54. Other constructions are substantially the same as those of the first embodiment.

As for the initial check function section as described above, too, the relationship between the on and off states of the switching elements 52, 53 and the broken states of the wirings A, B is substantially the same as the relationship in the first embodiment shown in FIG. 3. Therefore, by executing the abnormality detection process that is substantially the same as that in the first embodiment shown in FIG. 4, it is possible to detect a broken wiring failure of the wirings A, B. Hence, the fourth embodiment can achieve substantially the same advantages as the first embodiment.

### Other Embodiments

The above-described embodiments have been described in conjunction with the cases where the switching elements 52, 53 are disposed on the current supplying line that connects between the electric power source 56 and the ground and the actuator 80, and the detection of a broken wiring failure is performed as an example of the detection of an electrical abnormality. However, these are merely illustrative. For example, the circuit constructions shown in the foregoing embodiments may also be used to detect a short-circuit failure as well. The cases of short circuit include a ground short circuit in which the state of the high side or low side of the actuator 80 changes to the ground state, and a power source short circuit in which the state of the high side or low side of the actuator 80 changes to an electric power source 56—equivalent potential state. In these cases, regardless of the on or off state of the switching elements 52, 53, the voltage monitor value basically becomes a voltage that corresponds to the type of short circuit, so that the short circuit can be detected.

Furthermore, in the foregoing embodiments, although the switching elements 52, 53 are provided as an example of the switching unit, they are merely illustrative. The switching unit may be any device or the like as long as it is able to turn on and off the wiring A and the wiring B independently of each other.

Still further, the foregoing embodiments adopt, as an example of the actuator 80, the electric motor 45 for driving the pumps 41, 42 shown in FIG. 1, and the initial check has been described above with regard to the electric motor 45. However, this is also merely illustrative. The present invention is also applicable to, for example, the initial check of the solenoids of various control valves.

While the above description is of the preferred embodiments of the present invention, it should be appreciated that the invention may be modified, altered, or varied without deviating from the scope and fair meaning of the following claims.

What is claimed is:

1. A brake apparatus with an initial check function, comprising:
a brake circuit that generates a braking force corresponding to a brake operation of a driver;
an actuator provided in the brake circuit;
two switching units that are provided in a current supplying line for supplying a current from an electric power source, and that are connected in series with the actuator;
a drive unit that drives the actuator by operating the two switching units;
a voltage state detection unit that detects a voltage between the two switching units; and
an actuator state detection unit that determines whether the actuator is electrically normal or abnormal based on the voltage detected by the voltage state detection unit,
wherein when the drive unit outputs a signal for operating only one of the two switching units and thereafter outputs a signal for operating only the other one of the two switching units, the voltage between the two switching units is detected by the voltage state detection unit in each of a case of operation of only one of the two switching units and a case of operation of only the other one of the two switching units, and a state of the actuator is detected by the actuator state detection unit.

2. The brake apparatus with the initial check function according to claim 1, wherein only in a case where, when the signal for operating only one of the two switching units is output, it is determined by the actuator state detection unit that the actuator is electrically normal based on the voltage between the two switching units detected by the voltage state detection unit, the drive unit generates the output for operating only the other one of the two switching units.

3. The brake apparatus with the initial check function according to claim 1, wherein the actuator state detection unit determines the actuator is electrically abnormal if the voltage between the two switching units detected by the voltage state detection unit continues to be a voltage indicating that the actuator is electrically abnormal, for a predetermined time.

4. The brake apparatus with the initial check function according to claim 1, wherein the voltage state detection unit includes a first partial resistor and a second partial resistor that are connected in series with each other, and a current is supplied to the first partial resistor and the second partial resistor from the electric power source, and a line where the first partial resistor and the second partial resistor are connected in series is connected in parallel with the current supplying line where the two switching units and the actuator are connected in series.

5. The brake apparatus with the initial check function according to claim 4, wherein the actuator is disposed between the two switching units, and a potential between the one of the two switching units and the actuator is input to the voltage state detection unit.

6. The brake apparatus with the initial check function according to claim 4, wherein the actuator is disposed between the two switching units, and a potential between the other one of the two switching units and the actuator is input to the voltage state detection unit.

7. The brake apparatus with the initial check function according to claim 4, wherein the actuator is provided at a high side of the two switching units.

8. The brake apparatus with the initial check function according to claim 4, wherein the actuator is provided at a low side of the two switching units.

9. The brake apparatus with the initial check function according to claim 5, wherein when the drive unit drives one of the switching units, the actuator state detection unit determines that the actuator is electrically normal if the voltage detected by the voltage state detection unit is at a high level or a low level, and the actuator state detection unit determines that the actuator is electrically abnormal if the voltage detected by the voltage state detection unit is at a middle level.
